(19) United States
(12) Patent Application Publication
(10) Pub. No.: US 2019/0106147 A1
(43) Pub. Date: Apr. 11, 2019

(54) Method for Operating a Steering System of a Motor Vehicle

(71) Applicant: Robert Bosch Automotive Steering GmbH, Schwäbisch Gmünd (DE)

(72) Inventors: Philipp Schreiner, Marpingen (DE); Eugen Sworowski, Lorch (DE)

(73) Assignee: Robert Bosch Automotive Steering GmbH, Schwäbisch Gmünd (DE)

(21) Appl. No.: 15/763,382

(22) PCT Filed: Sep. 26, 2016
(86) PCT No.: PCT/EP2016/072788

§ 371 Date: Mar. 26, 2018

(30) Foreign Application Priority Data
Oct. 6, 2015 (DE) 10 2015 116 929.0

(51) Int. Cl. B62D 5/04; B60R 16/03; H02P 29/024

(52) U.S. Cl. CPC B62D 5/0463; H02P 29/0241; B62D 5/0481; B60R 16/03

(57) ABSTRACT

A method for operating a steering system of a motor vehicle with a power steering system for introducing an assist torque into a steering gearbox includes operating at least two electromechanical actuators on a common vehicle electrical system or on different vehicle electrical systems. The method further includes determining an overvoltage of the vehicle electrical system. The method further includes determining a respective setpoint assist torque of the at least two electromechanical actuators such that the overvoltage of the vehicle electrical system is reduced.

The invention concerns a method for operating a steering system of a motor vehicle according to the preamble of claim 1.

Power steering systems for applying a setpoint assist torque to a steering gearbox of a steering system are generally known.

Furthermore, it is known for example that voltage peaks can result from switching off larger loads on a vehicle electrical system, which can result in damage to components connected to the vehicle electrical system.

Thus, for example, it is known from DE 10 2013 224 106 A1 that load shedding can result from switching off loads in a connected vehicle electrical system or from cable damage. A method for operating a vehicle electrical system with a generator-powered electrical machine is proposed.

Consequently, it is the object of the invention to improve the stability of the vehicle electrical system.

The object underlying the invention is achieved by a method for operating a steering system of a motor vehicle as claimed in claim 1. Advantageous developments are stated in the subordinate claims. Important features for the invention are also to be found in the following description and in the drawing, wherein the feature can be important to the invention both on its own and in different combinations without explicit reference being made thereto again.

It is proposed that at least two electromechanical actuators are operated on a common vehicle electrical system or on a respective vehicle electrical system and that an overvoltage of the vehicle electrical system is determined. Furthermore, a respective setpoint assist torque of the at least two electromechanical actuators is determined so that the overvoltage of the vehicle electrical system is reduced. This advantageously enables the steering system to be used to reduce an overvoltage in the form of a voltage peak. In particular, voltage peaks result from switching off larger loads, and damage to further components can be prevented by the proposed method and the reduction of the corresponding overvoltage. Advantageously, a power steering system can have a short reaction time, so that the overvoltage can be safely reduced in an operational power steering system. Advantageously, a higher current can be drawn by the power steering system compared to other components, whereby the overvoltage can be safely reduced.

In one advantageous embodiment, the electromechanical actuators are operated in opposition to reduce the overvoltage. Said opposite operation advantageously results in essentially no mechanical movement related to the reduction of the overvoltage. Rather, both actuators operate oppositely to each other to reduce the overvoltage, thus drawing a high current from the vehicle electrical system and converting the current into heat to reduce the overvoltage.

In an advantageous embodiment, a load demand to reduce the overvoltage is determined. By determining the load demand, the overvoltage of the vehicle electrical system can be reduced.

In one advantageous embodiment, a first electromechanical actuator of the electromechanical actuators is operated with a first setpoint assist torque that is increased by the load demand. A second electromechanical actuator of the electromechanical actuators is operated with a second setpoint assist torque that is reduced by the load demand. This enables a total assist torque to be introduced into the steering gearbox and the load demand for reducing the overvoltage to be met at the same time. This results in an assist torque demanded by the driver or by the vehicle itself in an autonomous steering mode being able to be introduced into the steering gearbox and the load demand being implemented at the same time.

In one advantageous embodiment, a vehicle electrical system voltage is determined. The load demand is determined as a function of the vehicle electrical system voltage. Advantageously, the vehicle electrical system can thus be observed and a response by the steering system to an overvoltage of the vehicle electrical system can be implemented by means of the load demand.

In one advantageous embodiment, the load demand is specified by means of a message from a bus system. It is thereby advantageously achieved that a voltage peak is fed to the steering system prematurely, for example in the event of completed load shedding, which correspondingly implements a response by means of the load demand in order to reduce the resulting overvoltage of the vehicle electrical system.

The single FIGURE of the drawing shows a steering system 2 with a power steering system 4 in a schematic form. Furthermore, the steering system 2 can also contain a superposition steering system 6. The steering system 2 comprises a steering gearbox 8, which is embodied for example as a rack and pinion steering gear. Likewise, the steering gearbox 8 can also be embodied as a ball nut gear.

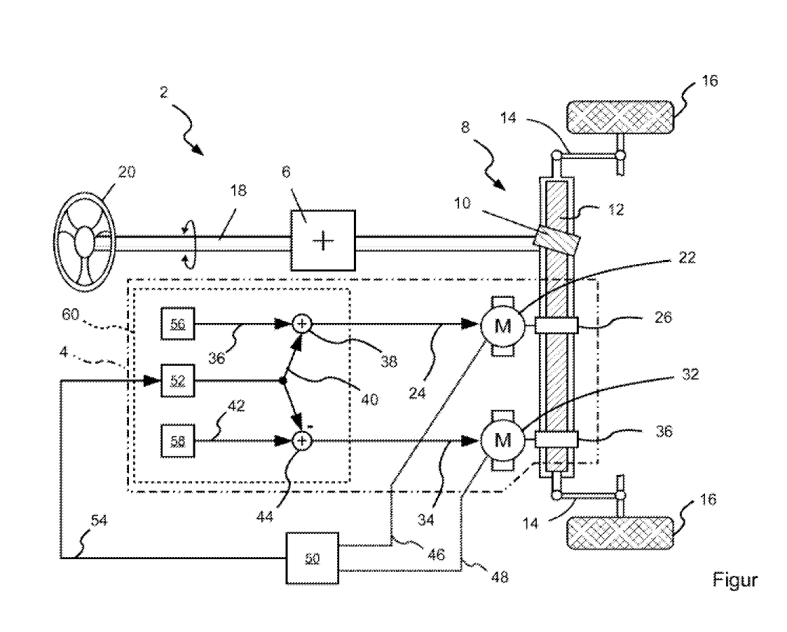

In this description, a rack and pinion steering system is primarily assumed. The steering gearbox 8 is connected via a pinion 10 and a rack 12 to a steering rod 14 on each side of the vehicle, each of which works in conjunction with a wheel 16. In principle, the steering system 2 in FIG. 1 is a suitable device from a number of possible embodiments for carrying out the method according to the invention. Other embodiments can for example be implemented by other steering gearboxes and/or by another arrangement of drives. Furthermore, further sensors can be disposed in the steering system 2, the arrangement and implementation of which will not be discussed at this point.

A steering means 20, for example a steering wheel, is disposed on a torsion bar. By means of the superposition steering system 6, a steering angle applied by the driver of the vehicle up to the steering gearbox 8 can be increased or reduced. Said difference in steering means, which is introduced by the superposition steering system 6 into the steering gearbox 8, is also referred to as an auxiliary steering angle. Of course, instead of a torsion bar, a steering column can be disposed between the steering means 20 and the superposition steering system 6. In said embodiment, the torsion bar 18 is disposed between the superposition steering system 6 and the power steering system 4 or the steering gearbox 8.

A first electromechanical actuator 22 introduces a setpoint assist torque 24 into the steering gearbox 8 via a gearbox 26 and the rack 12. A second electromechanical actuator 32 introduces a setpoint assist torque 34 into the steering gearbox 8 via a gearbox 36 and the rack 12. The first and second actuators 22, 32 are embodied as electric motors and the corresponding setpoint assist torque 24 or 34 is fed in a form that is not shown to suitable power electronics that operate the respective actuator 22, 32.

The first setpoint assist torque 24 results from the addition of a setpoint assist torque 36 determined for the first actuator 22 and a load demand 40 at an addition point 38. The second assist torque 34 results from the subtraction of the load demand 40 from a further setpoint assist torque 42 determined for the second actuator 32 at an addition point 44. Consequently, no difference in the total torque that is introduced into the steering gearbox 8 results from the load demand 40, which has the same dimension as the assist torque 24, 34, 36 and 42. At the same time, an opposing action of the electromechanical actuators 22 and 32 results, which causes a partial torque acting oppositely via the rack 12 and hence results in energy that is converted into heat in the respective actuator 22, 32. Consequently energy consumption can be realized by means of the load demand 40 that exceeds that which is required to produce the total torque.

The actuators 22 and 32 are connected via respective lines 46 and 48 to a common vehicle electrical system 50 of the motor vehicle and draw the electrical energy thereof via the common vehicle electrical system 50. Additional energy can be drawn from the common vehicle electrical system 50 by means of the load demand 40. Of course, the actuators 22 and 32 can also be supplied with electrical energy in a form that is not shown from two mutually independently operated, redundant vehicle electrical systems. Consequently, the descriptions are not only concerned with a common vehicle electrical system 50. Rather, the present description can easily be transferred to a number of different vehicle electrical systems, each associated with one of the actuators 22, 32 for energy supply.

The load demand 40 is determined by means of a block 52, to which an overvoltage of the vehicle electrical system 50 or one of the redundant vehicle electrical systems is signaled by means of a signal 54. Thus, for example, the signal 54 can be a voltage signal that is monitored by means of the block 52. Depending on the level of the determined overvoltage, for example the load demand 40 can be determined in the form of an oppositely acting steering torque by means of a characteristic field or a characteristic curve. In a further embodiment, the signal 54 can be a message on a bus system of the motor vehicle, by means of which the load demand 40 is produced by the block 52. Of course, a combination of the above two embodiments is also conceivable. Likewise, other variables relating to the vehicle electrical system 50 can be determined in order to detect an overvoltage.

The setpoint assist torque 36 is determined by means of a block 56. The setpoint assist torque 42 is determined by means of a block 58. For this purpose, blocks 56 and are coordinated so that a total torque can be introduced into the steering gearbox 8 that essentially corresponds to the addition of the setpoint steering torques 36 and 42.

The blocks 52, 56 and 58 and the addition points 38 and 44 are disposed in a control unit 60. Of course, the functionality can be distributed amongst a plurality of control units that communicate with each other. Furthermore, the control unit 60 contains a digital computing device for performing the steps of the method described here to carry out a computer program. The computer program is designed to embody one of the methods that are presented here. The computer program is stored on a memory medium. the method described here results in particular advantages when designing the further components that are disposed on the vehicle electrical system 50, which does not have to comprise overvoltage protection or only has to comprise overvoltage protection in a reduced form. Overall, the stability of the electrical system 50 increases, even with large load shedding. Overall, a vehicle electrical system 50 can thus be realized that can be less complex and thus more cost-effective.

1. A method for operating a steering system of a motor vehicle with a power steering system for introducing an assist torque into a steering gearbox, the method comprising:
operating at least two electromechanical actuators on a common vehicle electrical system or on different vehicle electrical systems;
determining an overvoltage of the vehicle electrical system; and
determining a respective setpoint assist torque of the at least two electromechanical actuators such that the overvoltage of the vehicle electrical system is reduced.

2. The method as claimed in claim 1, further comprising:
operating the at least two electromechanical actuators in opposition to reduce the overvoltage as a function of the respective setpoint assist torque.

3. The method as claimed in claim 1, further comprising:
determining a load demand to reduce the overvoltage.

4. The method as claimed in claim 3, further comprising:
operating a first electromechanical actuator of the at least two electromechanical actuators with a first setpoint assist torque that is increased by the load demand; and
operating a second electromechanical actuator of the at least two electromechanical actuators with a second setpoint assist torque that is reduced by the load demand.

5. The method as claimed in claim 3, further comprising:
determining a vehicle electrical system voltage; and
determining the load demand as a function of the vehicle electrical system voltage.

6. The method as claimed in claim 3, wherein the load demand is included in a message from a bus system.

7. The method as claimed in claim 1, wherein a computer program for a digital computing device is configured to carry out the method.

8. A steering system of a motor vehicle comprising:
a steering gearbox;
a power steering system configured to introduce an assist torque into the steering gearbox;
a control unit for operating the steering system of the motor vehicle the control unit having:
a digital computing device configured to carry out a computer program for performing a method for operating the steering system, the method including:
operating at least two electromechanical actuators on a common vehicle electrical system or on different vehicle electrical systems;
determining an overvoltage of the vehicle electrical system; and
determining a respective setpoint assist torque of the at least two electromechanical actuators such that the overvoltage of the vehicle electrical system is reduced.

9. The steering system as claimed in claim 8, further comprising:
a memory medium on which the computer program is stored.
